(19) United States
(12) Patent Application Publication
(10) Pub. No.: US 2020/0393780 A1
(43) Pub. Date: Dec. 17, 2020

(54) INTERMEDIATE TRANSFER MEMBER AND METHOD OF PRODUCTION THEREOF

(71) Applicant: Hewlett-Packard Development Company, L.P., Spring, TX (US)

(72) Inventors: Oshra RAVIV, Nes Ziona (IL); Ira YUDOVIN-FARBER, Nes Ziona (IL); Dima LIBSTER, Nes Ziona (IL); Sergey INOTAEV, Nes Ziona (IL)

(73) Assignee: Hewlett-Packard Development Company, L.P., Spring, TX (US)

(21) Appl. No.: 16/957,184

(22) PCT Filed: Jun. 12, 2018
(86) PCT No.: PCT/US2018/037055

§ 371 Date: Jun. 23, 2020

(51) Int. Cl. G03G 15/16; G03G 15/01; G03G 15/10; B32B 1/08; B32B 27/28; B32B 27/30; B32B 7/06

(52) U.S. Cl. CPC G03G 15/162; G03G 15/0131; G03G 15/10; B32B 7/06; B32B 27/283; B32B 27/304; B32B 1/08

(57) ABSTRACT

An intermediate transfer member, and a method of producing a seamless intermediate transfer member blanket for the intermediate transfer member are described. The method comprises applying a release formulation to an endless belt intermediate transfer member blanket precursor by contacting an applicator roller with an outer surface of the intermediate transfer member blanket precursor; curing the release formulation to form a release layer; applying a fluoropolymer membrane to a portion of the release layer; disengaging the applicator roller when the applicator roller is in contact with the fluoropolymer membrane, such that the fluoropolymer membrane is at least partially coated with the release formulation; and removing the fluoropolymer membrane from the surface of the release layer to form the seamless intermediate transfer member blanket.

Digital offset printing apparatus typically include an intermediate transfer member (ITM) onto which an image is applied prior to transferring the image to a substrate. Current intermediate transfer members comprise a silicone release layer as the surface layer onto which the ink image is applied. Silicone release layers are formed either by condensation curing, thermally assisted addition curing or UV curing reactions.

### BRIEF DESCRIPTION OF THE FIGURES

FIG. 1 is a schematic representation of a closed loop gravure printer.

FIG. 2 is a schematic illustration of an example of a liquid electrostatic printer.

FIG. 3 is a schematic illustration of an example of an intermediate transfer member.

FIG. 4 is a schematic cross-sectional diagram of an example of an ITM structure.

FIG. 5 is a schematic cross-sectional diagram of another example of an ITM structure.

FIG. 6 is a digital photograph of the release layer of a reference intermediate transfer member blanket.

FIG. 7a) shows a digital photograph of an intermediate transfer member blanket produced using a PTFE (polytetrafluoroethylene) membrane according to the present disclosure.

FIG. 7b) shows a digital photograph of an intermediate transfer member blanket produced using a PET (polyethylene terephthalate) membrane according to the present disclosure.

FIG. 7c) shows a digital photograph of an intermediate transfer member blanket produced using a PE (polyethylene) membrane according to the present disclosure.

FIG. 7d) shows a digital photograph of an intermediate transfer member blanket produced using a paper membrane according to the present disclosure.

### DETAILED DESCRIPTION

Before the intermediate transfer member, method of production thereof and related aspects are disclosed and described, it is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a”, “an” and “the” include plural referents unless the context clearly dictates otherwise.

As used herein, “electrophotographic ink composition” generally refers to an ink composition that is typically suitable for use in an electrophotographic printing process, sometimes termed an electrostatic printing process. The electrophotographic ink composition may include chargeable particles of the resin and the pigment dispersed in a liquid carrier, which may be as described herein.

As used herein, “copolymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

Unless otherwise stated, viscosity was measured using an AR-2000 model Rheometer from TAI (Thermal Analysis Instruments). The rheometer is used as a viscometer, by applying shear forces on the testing sample between two parallel plates. The sample is loaded between parallel plates at a known gap with an oscillatory (sinusoidal) shear profile of from 0.01 to 1,000 s⁻¹ at a temperature of 25° C. applied. Unless otherwise stated, the viscosity is the dynamic viscosity.

As used herein, “electrophotographic printing” or “electrostatic printing” generally refers to the process that provides an image that is transferred from a photoimaging plate either directly, or indirectly via an intermediate transfer member, to a print substrate. As such, the image is not substantially absorbed into the photoimaging plate on which it is applied. Additionally, “electrophotographic printers”, “electrophotographic printing apparatus”, “electrostatic printing apparatus” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g., an electric field having a field gradient of 1000 V/cm or more, or in some examples 1500 V/cm or more.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the abbreviation “acac” refers to acetylacetonate.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not only the explicitly recited values of about 1 wt. % to about 5 wt. %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

Unless otherwise stated, any feature described herein can be combined with any aspect or any other feature described herein.

In an aspect, there is provided a method of producing a seamless intermediate transfer member blanket, the method comprising:
applying a release formulation to an endless belt intermediate transfer member blanket precursor by contacting an applicator roller with an outer surface of the intermediate transfer member blanket precursor;
curing the release formulation to form a release layer;
applying a fluoropolymer membrane to a portion of the release layer;
disengaging the applicator roller when the applicator roller is in contact with the fluoropolymer membrane, such that the fluoropolymer membrane is at least partially coated with the release formulation; and
removing the fluoropolymer membrane from the surface of the release layer to form the seamless intermediate transfer member blanket.

In another aspect, there is provided an intermediate transfer member blanket for use in an electrostatic printer;
wherein the intermediate transfer member blanket is in the form of an endless belt and comprises a seamless release layer formed by curing a curable silicone release formulation comprising:
   a polyalkylsiloxane containing at least two vinyl groups; and
   a polyalkylsiloxane cross-linker containing at least two Si—H bonds.

In a further aspect, there is provided an intermediate transfer member comprising:
a seamless intermediate transfer member blanket obtainable by the method the method comprising:
   applying a release formulation to an endless belt intermediate transfer member blanket precursor by contacting an applicator roller with an outer surface of the intermediate transfer member blanket precursor;
   curing the release formulation to form a release layer;
   applying a fluoropolymer membrane to a portion of the release layer;
   disengaging the applicator roller when the applicator roller is in contact with the fluoropolymer membrane, such that the fluoropolymer membrane is at least partially coated with the release formulation; and
   removing the fluoropolymer membrane from the surface of the release layer to form the seamless intermediate transfer member blanket; and
a base on which the blanket is disposed.

Some methods of applying a release formulation to an intermediate transfer member blanket precursor use gravure printing techniques. Disengaging the gravure roller from the release layer results in formation of a seam in the release layer at the position in the release layer at which the gravure roller was disengaged. By applying a fluoropolymer membrane to a portion of the release layer and disengaging the gravure roller (applicator roller) when it is in contact with the fluoropolymer membrane, a seamless intermediate transfer member blanket can be formed.

### Method of Producing A Seamless Intermediate Transfer Member Blanket

In an aspect, there is provided a method of producing a seamless intermediate transfer member blanket, the method comprising: applying a release formulation to an endless belt intermediate transfer member blanket precursor by contacting an applicator roller with an outer surface of the intermediate transfer member blanket precursor; curing the release formulation to form a release layer; applying a fluoropolymer membrane to a portion of the release layer; disengaging the applicator roller when the applicator roller is in contact with the fluoropolymer membrane, such that the fluoropolymer membrane is at least partially coated with the release formulation; and removing the fluoropolymer membrane from the surface of the release layer to form the seamless intermediate transfer member blanket.

The method comprises applying a release formulation to an endless belt intermediate transfer member blanket precursor by contacting an applicator roller with an outer surface of the intermediate transfer member blanket precursor. In some examples, the endless belt intermediate transfer member blanket precursor may comprise one or more of a fabric layer, a compressible layer, and a conductive layer. In some examples, the endless belt intermediate transfer member blanket precursor may comprise a conductive layer and one or more of a fabric layer and a compressible layer, with the release formulation being applied to the conductive layer. In some examples, the endless belt intermediate transfer member blanket precursor may comprise one or more of a fabric layer, a compressible layer, a conductive layer and a soft compliant layer. In some examples, the endless belt intermediate transfer member blanket precursor may comprise a soft compliant layer and one or more of a fabric layer, a compressible layer and a conductive layer, with the release formulation being applied to the soft compliant layer. In some examples the release formulation is as described herein.

In some examples, the endless belt intermediate transfer member blanket precursor is formed by joining the ends of an intermediate transfer member blanket precursor. In some examples, the endless belt intermediate transfer member blanket precursor is formed as an endless belt. In some examples, the endless belt intermediate transfer member blanket precursor is formed from an endless belt fabric layer, wherein the endless belt fabric layer may be a flexible tube.

In some examples, the outer surface of the intermediate transfer member blanket precursor is the outer surface of a compressible layer, a conductive layer or a soft compliant layer. In some examples, the outer surface of the intermediate transfer member blanket precursor is the outer surface of a conductive layer. In some examples, the outer surface of the intermediate transfer member blanket precursor is the outer surface of a soft compliant layer.

In some examples, the applicator roller contacts the outer surface of the intermediate transfer member blanket precursor at an initial roller contact point. In some examples, the fluoropolymer membrane is applied to the initial roller contact point. In some examples, the fluoropolymer membrane is applied to a portion of the release layer other than at the initial roller contact point. In some examples, the fluoropolymer membrane is applied to the release layer in the vicinity of the initial roller contact point.

In some examples, an impression roller is positioned to provide a nip point between the applicator roller and the impression roller.

In some examples, the release formulation is cured to form the release layer by a method selected from condensation curing, thermal curing and UV curing. In some examples, the release formulation is cured by a method selected from thermal curing and UV curing.

In some examples, the release formulation is cured by thermal curing. In some examples, the release formulation is cured by UV curing.

In some examples, the release formulation is selected from condensation curable release formulations, thermally curable release formulations and UV curable release formulations. In some examples, the release formulation is selected from thermally curable release formulations and UV curable release formulations. In some examples, the release formulation is a thermally curable release formulation. In some examples, the release formulation is a UV curable release formulation.

The applicator roller is disengaged when the applicator roller is in contact with the fluoropolymer membrane, such that the fluoropolymer membrane is at least partially coated with the release formulation. In some examples, the contact portion of the applicator roller is entirely in contact with the fluoropolymer membrane when the applicator roller is disengaged.

In some examples, the fluoropolymer membrane is removed from the surface of the release layer before the release formulation that is partially coated on the fluoropolymer membrane is cured. In some examples, the release formulation coated on the fluoropolymer membrane is cured before the fluoropolymer membrane is removed from the surface of the release layer.

In some examples, the applicator roller may comprise a gravure coating roller, a rod coating roller, a roll coating roller or a reverse roll coating roller. In some examples, the applicator roller may comprise a gravure coating roller. In some examples, the applicator roller comprises gravure cells on the surface of the applicator roller.

In some examples, the release formulation is applied onto the intermediate transfer member blanket precursor at a gravure volume of 5 cm²/m³ or more, in some examples, 10 cm²/m³ or more, in some examples, 11 cm²/m³ or more, in some examples, 12 cm²/m³ or more, in some examples, 13 cm²/m³ or more, in some examples, 14 cm²/m³ or more, in some examples, 15 cm²/m³ or more, in some examples, 20 cm²/m³ or more. In some examples, the release formulation is applied onto the intermediate transfer member blanket precursor at a gravure volume of 20 cm²/m³ or less, in some examples, 15 cm²/m³ or less, in some examples, 14 cm²/m³ or less, in some examples, 13 cm²/m³ or less, in some examples, 12 cm²/m³ or less, in some examples, 11 cm²/m³ or less, in some examples, 10 cm²/m³ or less, in some examples, 5 cm²/m³ or less. In some examples, the release formulation is applied onto the intermediate transfer member blanket precursor at a gravure volume of 5 cm²/m³ to 20 cm²/m³, in some examples, 10 cm²/m³ to 15 cm²/m³, in some examples, 11 cm²/m³ to 14 cm²/m³, in some examples, 12 cm²/m³ to 13 cm²/m³.

In some examples, the release layer has a thickness of 1 μm or more, in some examples, 2 μm or more, in some examples, 3 μm or more, in some examples, 4 μm or more, in some examples, 5 μm or more, in some examples, 6 μm or more, in some examples, 7 μm or more, in some examples, 8 μm or more, in some examples, 9 μm or more, in some examples, 10 μm or more. In some examples, the release layer has a thickness of 10 μm or less, in some examples, 9 μm or less, in some examples, 8 μm or less, in some examples, 7 μm or less, in some examples, 6 μm or less, in some examples, 5 μm or less, in some examples, 4 μm or less, in some examples, 3 μm or less, in some examples, 2 μm or less, in some examples, 1 μm or less. In some examples, the release layer has a thickness of 1 μm to 10 μm, in some examples, 2 μm to 9 μm, in some examples, 3 μm to 8 μm, in some examples, 4 μm to 7 μm, in some examples, 5 μm to 6 μm.

In some examples, the applicator roller speed is 1 m/min or more, in some examples, 2 m//min or more, in some examples, 3 m/min or more, in some examples, 4 m/min or more, in some examples, 5 m/min or more, in some examples, 6 m/min or more, in some examples, 7 m/min or more, in some examples, 8 m/min or more, in some examples, 9 m/min or more, in some examples, 10 m/min or more. In some examples, the applicator roller speed is 10 m/min or less, in some examples, 9 m/min or less, in some examples, 8 m/min or less, in some examples, 7 m/min or less, in some examples, 6 m/min or less, in some examples, 5 m/min or less, in some examples, 4 m/min or less, in some examples, 3 m/min or less, in some examples, 2 m/min or less, in some examples, 1 m/min or less. In some examples, the applicator roller speed is 1 m/min to 10 m/min, in some examples, 2 m/min to 9 m/min, in some examples, 3 m/min to 8 m/min, in some examples, 4 m/min to 7 m/min, in some examples, 5 m/min to 6 m/min.

In some examples, prior to applying the release formulation, a primer formulation is applied to the endless belt intermediate transfer member blanket precursor. In some examples, the primer formulation forms the outer surface of the intermediate transfer member blanket precursor onto which the release formulation is applied.

In some examples, the primer formulation is applied by contacting a primer applicator roller with the outer surface of the intermediate transfer member blanket precursor. In some examples, the primer applicator roller is disengaged once a complete primer layer has been formed on the intermediate transfer member blanket precursor such that the release formulation is not applied directly to any part of the intermediate transfer member blanket precursor. In some examples, the primer applicator roller is disengaged when it is in contact with the fluoropolymer membrane, such that the fluoropolymer membrane is at least partially coated with the primer formulation.

In some examples, the primer formulation may be applied by extrusion, calendering, lamination, gravure coating, rod coating, flexo coating, screen coating, spray coating, roll coating, reverse roll coating, gap coating, slot die coating, immersion coating, curtain coating, air knife coating, flood coating, lithography or combinations thereof.

In some examples, the primer formulation is cured to form a primer layer before application of the release formulation to the outer surface of the intermediate transfer member blanket precursor. In some examples, the primer formulation and the release formulation are cured simultaneously.

In some examples, the primer formulation is applied onto the intermediate transfer member blanket precursor at a gravure volume of 1 cm²/m³ or more, in some examples, 5 cm²/m³ or more, in some examples, 6 cm²/m³ or more, in some examples, 7 cm²/m³ or more, in some examples, 8 cm²/m³ or more, in some examples, 9 cm²/m³ or more, in some examples, 10 cm^{2/}m³ or more, in some examples, 15 cm²/m³ or more. In some examples, the primer formulation is applied onto the intermediate transfer member blanket precursor at a gravure volume of 15 cm²/m³ or less, in some examples, 10 cm²/m³ or less, in some examples, 9 cm²/m³ or less, in some examples, 8 cm²/m³ or less, in some examples, 7 cm²/m³ or less, in some examples, 6 cm²/m³ or less, in some examples, 5 cm^{2/}m³ or less, in some examples, 1 cm²/m³ or less. In some examples, the primer formulation was applied onto the intermediate transfer member blanket precursor at a gravure volume of 1 cm²/m³ to 15 cm²/m³, in some examples, 5 cm²/m³ to 10 cm²/m³, in some examples, 6 cm²/m³ to 9 cm²/m³, in some examples, 7 cm²/m³ to 8 cm²/m³.

In some examples, the primer layer has a thickness of 0.5 μm or more, in some examples, 1 μm or more, in some examples, 1.5 μm or more, in some examples, 2 μm or more, in some examples, 2.5 μm or more, in some examples, 3 μm or more, in some examples, 3.5 μm or more, in some examples, 4 μm or more, in some examples, 4.5 μm or more, in some examples, 5 μm or more. In some examples, the primer layer has a thickness of 5 μm or less, in some examples, 4.5 μm or less, in some examples, 4 μm or less, in some examples, 3.5 μm or less, in some examples, 3 μm or less, in some examples, 2.5 μm or less, in some examples, 2 μm or less, in some examples, 1.5 μm or less, in some examples, 1 μm or less, in some examples, 0.5 μm or less. In some examples, the primer layer has a thickness of 0.5 μm to 5 μm, in some examples, 1 μm to 4.5 μm, in some examples, 1.5 μm to 4 μm, in some examples, 2 μm to 3.5 μm, in some examples, 2.5 μm to 3 μm.

In some examples, the primer applicator roller speed is 1 m/min or more, in some examples, 2 m//min or more, in some examples, 3 m/min or more, in some examples, 4 m/min or more, in some examples, 5 m/min or more, in some examples, 6 m/min or more, in some examples, 7 m/min or more, in some examples, 8 m/min or more, in some examples, 9 m/min or more, in some examples, 10 m/min or more. In some examples, the primer applicator roller speed is 10 m/min or less, in some examples, 9 m/min or less, in some examples, 8 m/min or less, in some examples, 7 m/min or less, in some examples, 6 m/min or less, in some examples, 5 m/min or less, in some examples, 4 m/min or less, in some examples, 3 m/min or less, in some examples, 2 m/min or less, in some examples, 1 m/min or less. In some examples, the primer applicator roller speed is 1 m/min to 10 m/min, in some examples, 2 m/min to 9 m/min, in some examples, 3 m/min to 8 m/min, in some examples, 4 m/min to 7 m/min, in some examples, 5 m/min to 6 m/min.

In some examples, the method is performed on a closed loop gravure printing press.

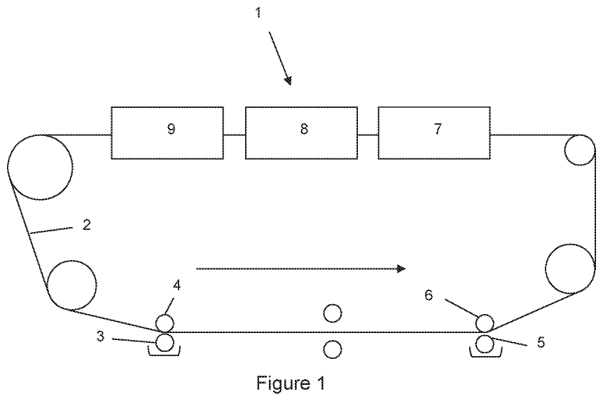

FIG. 1 shows a schematic illustration of an example of a closed loop gravure printing press 1 which may be used in the methods described herein. An endless belt intermediate transfer member blanket precursor 2 is positioned in the closed loop gravure printing press 1. The endless belt intermediate transfer member blanket precursor 2 travels around the closed loop gravure printing press shown in FIG. 1 in an anti-clockwise direction. Primer formulation is applied to the endless belt intermediate transfer member blanket precursor 2 by contacting primer applicator roller 3 with the outer surface of the intermediate transfer member blanket precursor 2. An impression roller 4 is positioned to provide a nip point between the primer applicator roller 3 and the impression roller 4. Release formulation is applied to the endless belt intermediate transfer member blanket precursor 2 by contacting applicator roller 5 with the outer surface of the intermediate transfer member blanket precursor 2. Impression roller 6 is positioned to provide a nip point between the applicator roller 5 and the impression roller 6. The release formulation is cured by ovens 7, 8 and 9 to form a release layer. A fluoropolymer membrane (not shown) is applied to a portion of the cured release layer. The primer applicator roller 3 may be disengaged once a complete primer layer has been formed on the intermediate transfer member blanket precursor 2 such that the release formulation is not applied directly to any part of the intermediate transfer blanket precursor. Alternatively, the primer applicator roller 3 may be disengaged when it is in contact with the fluoropolymer membrane, such that the fluoropolymer membrane is at least partially coated with the primer formulation. The applicator roller 5 is disengaged when the applicator roller is in contact with the fluoropolymer membrane such that the fluoropolymer membrane is at least partially coated with the release formulation. The fluoropolymer membrane is removed from the surface of the release layer to form the seamless intermediate transfer member blanket.

### Fluoropolymer Membrane

The method comprises applying a fluoropolymer membrane to a portion of the release layer.

As used herein, the term “fluoropolymer” includes polymers that are made from at least one fluorine-containing monomer. In some examples, the fluoropolymer is a copolymer comprising monomers that contain no fluorine or other halogen atoms. In some examples, the fluoropolymer comprises no carbon-hydrogen bonds. In some examples, the fluoropolymer comprises perfluorinated monomers. In some examples, the fluoropolymer consists of perfluorinated monomers. In some examples, the fluoropolymer comprises perfluoroalkyl monomers. In some examples, a perfluoroalkyl monomer is a monomer containing only carbon-fluorine bonds, other carbon-heteroatom bonds and carbon-carbon bonds. In some examples, a perfluoroalkyl monomer is a monomer containing only carbon-fluorine and carbon-carbon bonds.

In some examples, the fluoropolymer is selected from polytetrafluoroethylene; perfluoroalkoxy alkane polymers; and fluorinated ethylene-propylene copolymers. In some examples, the fluoropolymer is polytetrafluoroethylene.

In some examples, the fluorinated ethylene-propylene copolymers are perfluorinated ethylene-propylene copolymers. In some examples, fluorinated ethylene-propylene copolymers are copolymers of hexafluoropropylene and tetrafluoroethylene. In some examples, perfluoroalkoxy alkane polymers are copolymers of tetrafluoroethylene and perfluorovinyl ethers, wherein the perfluorovinyl ether may have the formula C₂F₃OR^{f} in which R^{f} is a perfluorinated alkane group. In some examples, the perfluorinated alkane group may be a C1 to C10 perfluorinated alkane group, in some examples, a C1 to C5 perfluorinated alkane group, in some examples, a group selected perfluoromethyl, perfluoroethyl, perfluorpropyl and perfluorobutyl groups.

In some examples, the fluoropolymer membrane has a thickness of 10 μm or more, in some examples, 15 μm or more, in some examples, 16 μm or more, in some examples, 17 μm or more, in some examples, 18 μm or more, in some examples, 19 μm or more, in some examples, 20 μm or more, in some examples, 21 μm or more, in some examples, 22 μm or more, in some examples, 23 μm or more, in some examples, 24 μm or more, in some examples, 25 μm or more, in some examples, 26 μm or more, in some examples, 27 μm or more, in some examples, 28 μm or more, in some examples, 29 μm or more, in some examples, 30 μm or more, in some examples, 35 μm or more. In some examples, the fluoropolymer membrane has a thickness of 35 μm or less, in some examples, 30 μm or less, in some examples, 29 μm or less, in some examples, 28 μm or less, in some examples, 27 μm or less, in some examples, 26 μm or less, in some examples, 25 μm or less, in some examples, 24 μm or less, in some examples, 23 μm or less, in some examples, 22 μm or less, in some examples, 21 μm or less, in some examples, 20 μm or less, in some examples, 19 μm or less, in some examples, 18 μm or less, in some examples, 17 μm or less, in some examples, 16 μm or less, in some examples, 15 μm or less, in some examples, 10 μm or less. In some examples, the fluoropolymer has a thickness of 10 μm to 35 μm, in some examples, 15 μm to 30 μm, in some examples, 16 μm to 29 μm, in some examples, 17 μm to 28 μm, in some examples, 18 μm to 27 μm, in some examples, 19 μm to 26 μm, in some examples, 20 μm to 25 μm, in some examples, 21 μm to 24 μm, in some examples, 22 μm to 23 μm.

In some examples, the fluoropolymer membrane may have a weight of 1 g/m³ or more, in some examples, 5 g/m³ or more, in some examples, 6 g/m³ or more, in some examples, 7 g/m³ or more, in some examples, 8 g/m³ or more, in some examples, 9 g/m³ or more, in some examples, 10 g/m³ or more, in some examples, 11 g/m³ or more, in some examples, 12 g/m³ or more, in some examples, 13 g/m³ or more, in some examples, 14 g/m³ or more, in some examples, 15 g/m³ or more, in some examples, 16 g/m³ or more, in some examples, 17 g/m³ or more, in some examples, 18 g/m³ or more, in some examples, 19 g/m³ or more, in some examples, 20 g/m³ or more, in some examples, 25 g/m³ or more. In some examples, the fluoropolymer membrane may have a weight of 25 g/m³ or less, in some examples, 20 g/m³ or less, in some examples, 19 g/m³ or less, in some examples, 18 g/m³ or less, in some examples, 17 g/m³ or less, in some examples, 16 g/m³ or less, in some examples, 15 g/m³ or less, in some examples, 14 g/m³ or less, in some examples, 13 g/m³ or less, in some examples, 12 g/m³ or less, in some examples, 11 g/m³ or less, in some examples, 10 g/m³ or less, in some examples, 9 g/m³ or less, in some examples, 8 g/m³ or less, in some examples, 7 g/m³ or less, in some examples, 6 g/m³ or less, in some examples, 5 g/m³ or less, in some examples, 1 g/m³ or less. In some examples, the fluoropolymer membrane may have a weight of 1 g/m³ to 25 g/m³, in some examples, 5 g/m³ to 20 g/m³, in some examples, 6 g/m³ to 19 g/m³, in some examples, 7 g/m³ to 18 g/m³, in some examples, 8 g/m³ to 17 g/m³, in some examples, 9 g/m³ to 16 g/m³, in some examples, 10 g/m³ to 15 g/m³, in some examples, 11 g/m³ to 14 g/m³, in some examples, 12 g/m³ to 13 g/m³.

In some examples, the fluoropolymer membrane is applied to a 100 mm or more portion of the circumference of the release layer, in some examples, 125 mm or more, in some examples, 150 mm or more, in some examples, 175 mm or more, in some examples, 180 mm or more, in some examples, 185 mm or more, in some examples, 190 mm or more, in some examples, 195 mm or more, in some examples, 200 mm or more, in some examples, 205 mm or more, in some examples, 210 mm or more, in some examples, 215 mm or more, in some examples, 220 mm or more, in some examples, 225 mm or more, in some examples, 250 mm or more, in some examples, 275 mm or more, in some examples, 300 mm or more portion of the circumference of the release layer. In some examples, the fluoropolymer membrane is applied to a 300 mm or less portion of the circumference of the release layer, in some examples, 275 mm or less, in some examples, 250 mm or less, in some examples, 225 mm or less, in some examples, 220 mm or less, in some examples, 215 mm or less, in some examples, 210 mm or less, in some examples, 205 mm or less, in some examples, 200 mm or less, in some examples, 195 mm or less, in some examples, 190 mm or less, in some examples, 185 mm or less, in some examples, 180 mm or less, in some examples, 175 mm or less, in some examples, 150 mm or less, in some examples, 125 mm or less, in some examples, 100 mm or less portion of the circumference of the release layer. In some examples, the fluoropolymer membrane is applied to a 100 mm to 300 mm portion of the circumference of the release layer, in some examples, 125 mm to 275 mm, in some examples, 150 mm to 250 mm, in some examples, 175 mm to 225 mm, in some examples, 180 mm to 220 mm, in some examples, 185 mm to 215 mm, in some examples, 190 mm to 210 mm, in some examples, 195 mm to 205 mm, in some examples, 195 mm to 200 mm portion of the circumference of the release layer.

In some examples, the fluoropolymer membrane is applied to 1% or more of the circumference of the outer surface of the endless belt intermediate transfer member blanket precursor, in some examples, 1.5% or more, in some examples, 2% or more, in some examples, 2.5% or more, in some examples, 3% or more, in some examples, 3.5% or more, in some examples, 4% or more, in some examples, 4.5% or more, in some examples, 5% or more, in some examples, 5.5% or more, in some examples, 6% or more, in some examples, 6.5% or more, in some examples, 7% or more, in some examples, 7.5% or more, in some examples, 8% or more, in some examples, 8.5% or more, in some examples, 9% or more, in some examples, 9.5% or more, in some examples, 10% or more of the circumference of the outer surface of the endless belt intermediate transfer member blanket precursor. In some examples, the fluoropolymer membrane is applied to 10% or less of the circumference of the outer surface of the endless belt intermediate transfer member blanket precursor, in some examples, 9.5% or less, in some examples, 9% or less, in some examples, 8.5% or less, in some examples, 8% or less, in some examples, 7.5% or less, in some examples, 7% or less, in some examples, 6.5% or less, in some examples, 6% or less, in some examples, 5.5% or less, in some examples, 5% or less, in some examples, 4.5% or less, in some examples, 4% or less, in some examples, 3.5% or less, in some examples, 3% or less, in some examples, 2.5% or less, in some examples, 2% or less, in some examples, 1.5% or less, in some examples, 1% or less of the circumference of the outer surface of the endless belt intermediate transfer member blanket precursor. In some examples, the fluoropolymer membrane is applied to 1% to 10% of the circumference of the outer surface of the endless belt intermediate transfer member blanket precursor, in some examples, 1.5% to 9.5%, in some examples, 2% to 9%, in some examples, 2.5% to 8.5%, in some examples, 3% to 8%, in some examples, 3.5% to 7.5%, in some examples, 4% to 7% in some examples, 4.5% to 6.5%, in some examples, 5% to 6%, in some examples, 5% to 5.5% of the circumference of the outer surface of the endless belt intermediate transfer member blanket precursor.

In some examples, the fluoropolymer membrane is dimensioned so as to at least equal the contact area between the endless belt intermediate transfer member blanket precursor and the applicator roller used to apply the release formulation. In some examples, the fluoropolymer membrane is dimensioned so as to be greater than the contact area between the endless belt intermediate transfer member blanket precursor and the applicator roller used to apply the release formulation.

### Release Formulation

The release formulation may be a condensation curing release formulation, a thermally curable release formulation or a UV curable release formulation. In some examples, the release formulation may be a thermally curable release formulation or a UV curable release formulation. In some examples, the release formulation may be a thermally curable release formulation. In some examples, the release formulation may be a UV curable release formulation.

In some examples, the release formulation may comprise a polyalkylsiloxane containing at least two vinyl groups and a polyalkylsiloxane cross-linker containing at least two Si—H bonds. In some examples, the release formulation may comprise a polyalkylsiloxane containing at least two vinyl groups; a polyalkylsiloxane cross-linker containing at least two Si—H bonds; and a catalyst. In some examples, the release formulation may comprise a polyalkylsiloxane containing at least two vinyl groups; a polyalkylsiloxane cross-linker containing at least two Si—H bonds; a catalyst; and conductive particles.

In some examples, the release formulation may comprise a polyalkylsiloxane containing at least two vinyl groups; a polyalkylsiloxane cross-linker containing at least two Si—H bonds; a catalyst; and a thermal inhibitor; In some examples, the release formulation may comprise a polyalkylsiloxane containing at least two vinyl groups; a polyalkylsiloxane cross-linker containing at least two Si—H bonds; a catalyst; conductive particles and a thermal inhibitor.

### Polyalkylsiloxane Containing at Least Two Vinyl Groups

In some examples, the release formulation comprises a polyalkylsiloxane containing at least two vinyl groups. In some examples, the polyalkylsiloxane containing at least two vinyl groups is selected from a linear polyalkylsiloxane containing at least two vinyl groups, a branched polyalkylsiloxane containing at least two vinyl groups, a cyclic polyalkylsiloxane containing at least two vinyl groups and mixtures thereof. In some examples, the polyalkylsiloxane containing at least two vinyl groups is a linear polyalkylsiloxane containing at least two vinyl groups.

In some examples, the polyalkylsiloxane containing at least two vinyl groups comprises a vinyl-terminated polyalkylsiloxane having the following formula:

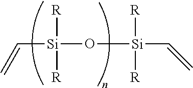

wherein each R is independently selected from C1 to C6 alkyl; and n is 1 or more.

In some examples, each R is independently selected from C1, C2, C3, C4, C5 and C6 alkyl. In some examples, each R is independently selected from methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R is independently selected from methyl, ethyl, n-propyl, isopropyl, n-butyl, sec-butyl, isobutyl, and tert-butyl. In some examples, each R is independently selected from methyl, ethyl, n-propyl, and isopropyl. In some examples, each R is the same. In some examples, each R is methyl.

In some examples, n is 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, n is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples, 5 or less, in some examples, 2 or less. In some examples, n is 1 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500.

In some examples, the vinyl-terminated polyalkylsiloxane has a viscosity at 25° C. of 250 mPa·s or more, in some examples, 300 mPa·s or more, in some examples, 350 mPa·s or more, in some examples, 400 mPa·s or more, in some examples, 450 mPa·s or more, in some examples, 500 mPa·s or more, in some examples, 550 mPa·s or more, in some examples 600 mPa·s or more, in some examples, 650 mPa·s or more, in some examples, 700 mPa·s or more, in some examples, about 750 mPa·s. In some examples, the vinyl-terminated polyalkylsiloxane has a viscosity at 25° C. of 750 mPa·s or less, in some examples, 700 mPa·s or less, in some examples, 650 mPa·s or less, in some examples, 600 mPa·s or less, in some examples, 550 mPa·s or less, in some examples, 500 mPa·s or less, in some examples, 450 mPa·s or less, in some examples, 400 mPa·s or less, in some examples, 350 mPa·s or less, in some examples, 300 mPa·s or less, in some examples, about 250 mPa·s. In some examples, the vinyl-terminated polyalkylsiloxane has a viscosity at 25° C. of 250 mPa·s to 750 mPa·s, in some examples, 300 mPa·s to 700 mPa·s, in some examples, 350 mPa·s to 650 mPa·s, in some examples, 400 mPa·s to 600 mPa·s, in some examples, 450 mPa·s to 550 mPa·s, in some examples, 450 mPa·s to 500 mPa·s.

In some examples, the vinyl-terminated polyalkylsiloxane may have a vinyl content of 0.05 mmol/g or more, in some examples, 0.06 mmol/g or more, in some examples, 0.07 mmol/g or more, in some examples, 0.08 mmol/g or more, in some examples, 0.09 mmol/g or more, in some examples, 0.1 mmol/g or more, in some examples, 0.11 mmol/g or more, in some examples, 0.12 mmol/g or more, in some examples, 0.13 mmol/g or more, in some examples, 0.14 mmol/g or more, in some examples, 0.15 mmol/g or more, in some examples, 0.16 mmol/g or more, in some examples, 0.17 mmol/g or more, in some examples, 0.18 mmol/g or more, in some examples, 0.19 mmol/g or more, in some examples, 0.2 mmol/g or more, in some examples, 0.3 mmol/g or more, in some examples, 0.4 mmol/g or more, in some examples, 0.5 mmol/g or more, in some examples, about 0.6 mmol/g. In some examples, the vinyl-terminated polyalkylsiloxane may have a vinyl content of 0.6 mmol/g or less, in some examples, 0.5 mmol/g or less, in some examples, 0.4 mmol/g or less, in some examples, 0.3 mmol/g or less, in some examples, 0.2 mmol/g or less, in some examples, 0.19 mmol/g or less, in some examples, 0.18 mmol/g or less, in some examples, 0.17 mmol/g or less, in some examples, 0.16 mmol/g or less, in some examples, 0.15 mmol/g or less, in some examples, 0.14 mmol/g or less, in some examples, 0.13 mmol/g or less, in some examples, 0.12 mmol/g or less, in some examples, 0.11 mmol/g or less, in some examples, 0.1 mmol/g or less, in some examples, 0.09 mmol/g or less, in some examples, 0.08 mmol/g or less, in some examples, 0.07 mmol/g or less, in some examples, 0.06 mmol/g or less, in some examples, about 0.05 mmol/g. In some examples, the vinyl-terminated polyalkylsiloxane may have a vinyl content of 0.05 mmol/g to 0.6 mmol/g, in some examples, 0.06 mmol/g to 0.5 mmol/g, in some examples, 0.07 mmol/g to 0.4 mmol/g, in some examples, 0.08 mmol/g to 0.3 mmol/g, in some examples, 0.09 mmol/g to 0.2 mmol/g, in some examples, 0.1 mmol/g to 0.19 mmol/g, in some examples, 0.11 mmol/g to 0.18 mmol/g, in some examples, 0.12 mmol/g to 0.17 mmol/g, in some examples, 0.13 mmol/g to 0.16 mmol/g, in some examples, 0.14 mmol/g to 0.15 mmol/g.

In some examples, the polyalkylsiloxane containing at least two vinyl groups comprises a pendent vinyl polyalkylsiloxane having the following formula:

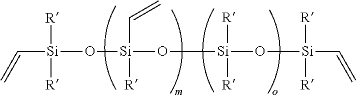

wherein each R′ is independently selected from C1 to C6 alkyl; and m is 1 or more; and o is 0 or more.

In some examples, each R′ is independently selected from C1, C2, C3, C4, C5 and C6 alkyl. In some examples, each R′ is independently selected from methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R′ is independently selected from methyl, ethyl, n-propyl, isopropyl, n-butyl, sec-butyl, isobutyl, and tert-butyl. In some examples, each R′ is independently selected from methyl, ethyl, n-propyl, and isopropyl. In some examples, each R′ is the same. In some examples, each R′ is methyl.

In some examples, m is 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, m is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples 5 or less. In some examples, m is 1 to 1000, in some examples, 2 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500.

In some examples, o is 0 or more, in some examples, 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, o is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples, 5 or less. In some examples, o is 1 to 1000, in some examples, 2 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500

In some examples, the pendent vinyl polyalkylsiloxane has a viscosity at 25° C. of 2500 mPa·s or more, in some examples, 2550 mPa·s or more, in some examples, 2600 mPa·s or more, in some examples, 2650 mPa·s or more, in some examples, 2700 mPa·s or more, in some examples, 2750 mPa·s or more, in some examples, 2800 mPa·s or more, in some examples, 2850 mPa·s or more, in some examples, 2900 mPa·s or more, in some examples, 2950 mPa·s or more, in some examples, 3000 mPa·s or more, in some examples, 3050 mPa·s or more, in some examples, 3100 mPa·s or more, in some examples, 3150 mPa·s or more, in some examples, 3200 mPa·s or more, in some examples, 3250 mPa·s or more, in some examples, 3300 mPa·s or more, in some examples, 3350 mPa·s or more, in some examples, 3400 mPa·s or more, in some examples, 3450 mPa·s or more, in some examples, about 3500 mPa·s. In some examples, the pendent vinyl polyalkylsiloxane has a viscosity at 25° C. of 3500 mPa·s or less, in some examples, 3450 mPa·s or less, in some examples, 3400 mPa·s or less, in some examples, 3350 mPa·s or less, in some examples, 3300 mPa·s or less, in some examples, 3250 mPa·s or less, in some examples, 3200 mPa·s or less, in some examples, 3150 mPa·s or less, in some examples, 3100 mPa·s or less, in some examples, 3050 mPa·s or less, in some examples, 3000 mPa·s or less, in some examples, 2950 mPa·s or less, in some examples, 2900 mPa·s or less, in some examples, 2850 mPa·s or less, in some examples, 2800 mPa·s or less, in some examples, 2750 mPa·s or less, in some examples, 2700 mPa·s or less, in some examples, 2650 mPa·s or less, in some examples, about 2500 mPa·s. In some examples, the pendent vinyl polyalkylsiloxane has a viscosity at 25° C. of 2500 mPa·s to 3500 mPa·s, in some examples, 2550 mPa·s to 3450 mPa·s, in some examples, 2600 mPa·s to 3400 mPa·s, in some examples, 2650 mPa·s to 3350 mPa·s, in some examples, 2700 mPa·s to 3300 mPa·s, in some examples, 2750 mPa·s to 3250 mPa·s, in some examples, 2800 mPa·s to 3200 mPa·s, in some examples, 2850 mPa·s to 3150 mPa·s, in some examples, 2900 mPa·s to 3100 mPa·s, in some examples, 2950 mPa·s to 3050 mPa·s, in some examples, 3000 mPa·s to 3050 mPa·s.

In some examples, the pendent vinyl polyalkylsiloxane may have a vinyl content of 0.1 mmol/g or more, 0.2 mmol/g or more, in some examples, 0.3 mmol/g or more, in some examples, 0.4 mmol/g or more, in some examples, 0.5 mmol/g or more, in some examples, 0.6 mmol/g or more, in some examples, 0.7 mmol/g or more, in some examples, 0.8 mmol/g or more, in some examples, 0.9 mmol/g or more, in some examples, 1 mmol/g or more, in some examples, 2 mmol/g or more. In some examples, the pendent vinyl polyalkylsiloxane may have a vinyl content of 2 mmol/g or less, in some examples, 1 mmol/g or less, in some examples, 0.9 mmol/g or less, in some examples, 0.8 mmol/g or less, in some examples, 0.7 mmol/g or less, in some examples, 0.6 mmol/g or less, in some examples, 0.5 mmol/g or less, in some examples, 0.4 mmol/g or less, in some examples, 0.3 mmol/g or less, in some examples, 0.2 mmol/g or less, in some examples, 0.1 mmol/g or less. In some examples, the pendent vinyl polyalkylsiloxane may have a vinyl content of 0.1 mmol/g to 2 mmol/g, in some examples, 0.2 mmol/g to 1 mmol/g, in some examples, 0.3 mmol/g to 0.9 mmol/g, in some examples, 0.4 mmol/g to 0.8 mmol/g, in some examples, 0.5 mmol/g to 0.7 mmol/g, in some examples, 0.3 mmol/g to 0.6 mmol/g.

In some examples, the pendent vinyl polyalkylsiloxane may be a random copolymer, a block copolymer, an alternating copolymer or a periodic copolymer. In some examples, the pendent vinyl polyalkylsiloxane may be a random copolymer.

In some examples, the polyalkylsiloxane containing at least two vinyl groups comprises a mixture of a vinyl-terminated polyalkylsiloxane having the following formula:

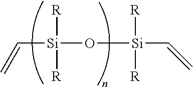

wherein each R is independently selected from C1 to C6 alkyl; and n is 1 or more; and a pendent vinyl polyalkylsiloxane having the following formula:

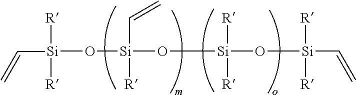

wherein each R′ is independently selected from C1 to C6 alkyl; m is 1 or more; and o is 0 or more. In some examples, each R, each R′, n, m and o may be as defined above.

In some examples, the polyalkylsiloxane containing at least two vinyl groups comprises a vinyl-terminated polyalkylsiloxane and a pendent vinyl polyalkylsiloxane. In some examples, the polyalkylsiloxane containing at least two vinyl groups comprises a mixture of vinyl-terminated polyalkylsiloxane and pendent vinyl polyalkylsiloxane in a ratio of from 1:10 to 10:1. In some examples, the polyalkylsiloxane containing at least two vinyl groups comprises a mixture of vinyl-terminated polyalkylsiloxane and pendent vinyl polyalkylsiloxane in a ratio of from 1:9 to 9:1 mixture, in some examples, from 1:8 to 8:1, in some examples, from 1:7 to 7:1, in some examples, from 1:6 to 6:1, in some examples, from 1:5 to 5:1, in some examples, from 1:4 to 4:1, in some examples, from 1:3 to 3:1, in some examples, from 1:2 to 2:1, in some examples, from 1:1 to 4:1.

Suitable examples of the polyalkylsiloxane containing at least two vinyl groups include Polymer VS 50, Polymer VS 100, Polymer VS 200, Polymer VS 500, Polymer VS 1000, Polymer VS 200, Polymer RV 100, Polymer RV 200, Polymer RV 500, available from Evonik Industries. Other suitable examples include DMS-V00, DMS-V03, DMS-V05, DMS-V21, DMS-V22, DMS-V25, DMS-V31, DMS-V33, DMS-V34, DMS-V35, DMS-V41, DMS-V42, DMS-V43, DMS-V46, DMS-V51, and DMS-V52 from Gelest Inc., Stroofstrasse 27, Geb.2901, 65933 Frankfurt am Main, Germany.

### Polyalkylsiloxane Cross-Linker Containing at Least Two Si—H Bonds

In some examples, the release formulation comprises a polyalkylsiloxane cross-linker containing at least two Si—H bonds. In some examples, the polyalkylsiloxane cross-linker is selected from a linear polyalkylsiloxane cross-linker, a branched polyalkylsiloxane cross-linker and a cyclic polyalkylsiloxane cross-linker. In some examples, the polyalkylsiloxane cross-linker containing at least two Si—H bonds is a linear polyalkylsiloxane cross-linker.

In some examples, the polyalkylsiloxane containing at least two Si—H bonds comprises a polyalkylsiloxane cross-linker having the following formula:

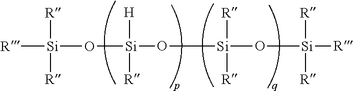

wherein each R″ is independently selected from C1 to C6 alkyl; each R′″ is independently selected from H and C1 to C6 alkyl; p is 2 or more; and q is 0 or more.

In some examples, each R″ is independently selected from C1, C2, C3, C4, C5 and C6 alkyl. In some examples, each R″ is independently selected from methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R″ is independently selected from methyl, ethyl, n-propyl, isopropyl, n-butyl, sec-butyl, isobutyl, and tea-butyl. In some examples, each R″ is independently selected from methyl, ethyl, n-propyl, and isopropyl. In some examples, each R″ is the same. In some examples, each R″ is methyl.

In some examples, each R′″ is independently selected from H, C1, C2, C3, C4, C5 and C6 alkyl. In some examples, each R′″ is independently selected from H, methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R′″ is independently selected from H, methyl, ethyl, n-propyl, isopropyl, n-butyl, sec-butyl, isobutyl, and tert-butyl. In some examples, each R′″ is independently selected from H, methyl, ethyl, n-propyl, and isopropyl. In some examples, each R′″ is the same. In some examples, each R′″ is H or methyl.

In some examples, p is 2 or more, in some examples, 3 or more, in some examples, 4 or more, in some examples, 5 or more, in some examples, 6 or more, in some examples, 7 or more, in some examples, 8 or more, in some examples, 9 or more, in some examples, in some examples, 10 or more, in some examples, 20 or more, in some examples, 50 or more. In some examples, p is 50 or less, in some examples, 20 or less, in some examples, 10 or less, in some examples, 9 or less, in some examples, 8 or less, in some examples, 7 or less, in some examples 6 or less, in some examples, 5 or less, in some examples, 4 or less, in some examples, 3 or less, in some examples, 2 or less.

In some examples, p is 2 to 50, in some examples, 3 to 10, in some examples, 4 to 9, in some examples, 5 to 8, in some examples, 6 to 7.

In some examples, q is 0 or more, in some examples, 1 or more, in some examples, 2 or more, in some examples, 3 or more, in some examples, 4 or more, in some examples, 5 or more, in some examples, 6 or more, in some examples, 7 or more, in some examples, 8 or more, in some examples, 9 or more, in some examples, in some examples, 10 or more, in some examples, 20 or more, in some examples, 50 or more. In some examples, q is 50 or less, in some examples, 20 or less, in some examples, 10 or less, in some examples, 9 or less, in some examples, 8 or less, in some examples, 7 or less, in some examples 6 or less, in some examples, 5 or less, in some examples, 4 or less, in some examples, 3 or less, in some examples, 2 or less, in some examples, 1 or less. In some examples, q is 0 to 50, in some examples, 1 to 20, in some examples, 1 to 10, in some examples, 2 to 9, in some examples, 3 to 8, in some examples, 4 to 7, in some examples, 5 to 6.

In some examples, the polyalkylsiloxane cross-linker may be a random copolymer, a block copolymer, an alternating copolymer or a periodic copolymer. In some examples, the polyalkylsiloxane cross-linker may be a random copolymer.

In some examples, the polyalkylsiloxane cross-linker has a viscosity at 25° C. of 5 mPa·s or more, in some examples, 10 mPa·s or more, in some examples, 15 mPa·s or more, in some examples, 20 mPa·s or more, in some examples, 25 mPa·s or more, in some examples, 30 mPa·s or more, in some examples, 35 mPa·s or more, in some examples 40 mPa·s or more, in some examples, 45 mPa·s or more, in some examples, 50 mPa·s or more, in some examples, 55 mPa·s or more, in some examples, 60 mPa·s or more, in some examples, 65 mPa·s or more, in some examples, 70 mPa·s or more, in some examples, 75 or more, in some examples, about 80 mPa·s. In some examples, the polyalkylsiloxane cross-linker has a viscosity at 25° C. of 80 mPa·s or less, in some examples, 75 mPa·s or less, in some examples, 70 mPa·s or less, in some examples, 65 mPa·s or less, in some examples, 60 mPa·s or less, in some examples, 55 mPa·s or less, in some examples, 50 mPa·s or less, in some examples, 45 mPa·s or less, in some examples, 40 mPa·s or less, in some examples, 35 mPa·s or less, in some examples, 30 mPa·s or less, in some examples, 25 mPa·s or less, in some examples, 20 mPa·s or less, in some examples, 15 mPa·s or less, in some examples, about 10 mPa·s. In some examples, the polyalkylsiloxane cross-linker has a viscosity at 25° C. of 10 mPa·s to 80 mPa·s, in some examples, 15 mPa·s to 75 mPa·s, in some examples, 20 mPa·s to 70 mPa·s, in some examples, 25 mPa·s to 65 mPa·s, in some examples, 30 mPa·s to 60 mPa·s, in some examples, 35 mPa·s to 55 mPa·s, in some examples, 40 mPa·s to 50 mPa·s, in some examples, 40 mPa·s to 45 mPa·s.

In some examples, the polyalkylsiloxane cross-linker may have an Si—H content of 1 mmol/g or more, in some examples, 2 mmol/g or more, in some examples, 3 mmol/g or more, in some examples, 3.5 mmol/g or more, in some examples, 4 mmol/g or more, in some examples, 4.1 mmol/g or more, in some examples, 4.2 mmol/g or more, in some examples, 4.3 mmol/g or more, in some examples, 4.4 mmol/g or more, in some examples, 4.5 mmol/g or more, in some examples, 5 mmol/g or more, in some examples, 6 mmol/g or more, in some examples, 7 mmol/g or more, in some examples, about 8 mmol/g. In some examples, the polyalkylsiloxane cross-linker may have an Si—H content of 8 mmol/g or less, in some examples, 7 mmol/g or less, in some examples, 6 mmol/g or less, in some examples, 5 mmol/g or less, in some examples, 4.5 mmol/g or less, in some examples, 4.4 mmol/g or less, in some examples, 4.3 mmol/g or less, in some examples, 4.2 mmol/g or less, in some examples, 4.1 mmol/g or less, in some examples, 4 mmol/g or less, in some examples, 3.5 mmol/g or less, in some examples, 3 mmol/g or less, in some examples, 2 mmol/g or less, in some examples, about 1 mmol/g. In some examples, the polyalkylsiloxane cross-linker may have an Si—H content of 1 mmol/g to 8 mmol/g, in some examples, 2 mmol/g to 7 mmol/g, in some examples, 3 mmol/g to 6 mmol/g, in some examples, 3.5 mmol/g mmol/g to 5 mmol/g, in some examples, 4 mmol/g to 4.5 mmol/g, in some examples, 4.1 mmol/g to 4.4 mmol/g, in some examples, 4.2 mmol/g to 4.3 mmol/g.

Suitable examples of the polyalkylsiloxane cross-linker include Cross-linker 200, Cross-linker 210, Cross-linker 100, Cross-linker 101, Cross-linker 120, Cross-linker 125 or Cross-linker 190, available from Evonik Industries. Other suitable cross-linkers include HMS-031, HMS-071, HMS-082, HMS-013, and HMS-064 from Gelest Inc., Stroofstrasse 27, Geb.2901, 65933 Frankfurt am Main, Germany.

In some examples, the release formulation comprises a ratio of polyalkylsiloxane containing cross-linker to polyalkylsiloxane containing at least two vinyl groups such that the mole ratio of hydride to vinyl is from 4:1 to 1:4. In some examples, the release formulation comprises a ratio of polyalkylsiloxane containing cross-linker to polyalkylsiloxane containing at least two vinyl groups such that the mole ratio of hydride to vinyl is from 3:1 to 1:3, in some examples, 2.5:1 to 1:2.5, in some examples, 2:1 to 1:2, in some examples, 2:1 to 1:1, in some examples, about 2:1, for example, 2.1:1.

In some examples, the release formulation comprises a weight ratio of polyalkylsiloxane containing cross-linker to polyalkylsiloxane containing at least two vinyl groups of from 1:20 to 1:1, in some examples, 1:19 to 1:2, in some examples, 1:18 to 1:3, in some examples, 1:17 to 1:4, in some examples, 1:16 to 1:5, in some examples, 1:15 to 1:6, in some examples, 1:14 to 1:7, in some examples, 1:13 to 1:8, in some examples, 1:12 to 1:9, in some examples, 1:11 to 1:10. In some examples, the release formulation comprises a weight ratio of polyalkylsiloxane containing cross-linker to polyalkylsiloxane containing at least two vinyl groups of about 1:10.

### Catalyst

In some examples, the release formulation comprises a catalyst. In some examples, the catalyst may be selected from thermally activated catalysts and UV activated catalysts. In some examples, the UV activated catalyst is [Pt(acac)₂]. In some examples, the thermally activated catalyst may be a platinum-based thermally activated catalyst. In some examples, the thermally activated catalyst may be the platinum divinyltetramethyldisiloxane complex, which is also known as the Karstedt catalyst.

In some examples, the release formulation may comprise (by weight) 2000 ppm or less catalyst, in some examples, 1500 ppm or less, in some examples, 1000 ppm or less, in some examples, 500 ppm or less, in some examples, 250 ppm or less, in some examples, 200 ppm or less, in some examples, 150 ppm or less, in some examples, 100 ppm or less, in some examples, 95 ppm or less, in some examples, 90 ppm or less, in some examples, 85 ppm or less, in some examples, 80 ppm or less, in some examples, 75 ppm or less, in some examples, 70 ppm or less, in some examples, 65 ppm or less, in some examples, 60 ppm or less, in some examples, 55 ppm or less, in some examples, 50 ppm or less, in some examples, 45 ppm or less, in some examples, 40 ppm or less, in some examples, 35 ppm or less, in some examples, 30 ppm or less, in some examples, 25 ppm or less, in some examples, 20 ppm or less, in some examples, 15 ppm or less, in some examples, 10 ppm or less, in some examples, 5 ppm or less, in some examples, about 1 ppm catalyst. In some examples, the release formulation may comprise (by weight) 1 ppm or more catalyst, in some examples, 5 ppm or more, in some examples, 10 ppm or more, in some examples, 15 ppm or more, in some examples, 20 ppm or more, in some examples, 25 ppm or more, in some examples, 30 ppm or more, in some examples, 40 ppm or more, in some examples, 45 ppm or more, in some examples, 50 ppm or more, in some examples, 55 ppm or more, in some examples, 60 ppm or more, in some examples, 65 ppm or more, in some examples, 70 ppm or more, in some examples, 75 ppm or more, in some examples, 80 ppm or more, in some examples, 85 ppm or more, in some examples, 90 ppm or more, in some examples, 95 ppm or more, in some examples, 100 ppm or more, in some examples, 125 ppm or more, in some examples, 150 ppm or more, in some examples, 200 ppm or more catalyst. In some examples, the release formulation may comprise (by weight) 1 ppm to 2000 ppm catalyst, in some examples, 5 ppm to 1500 ppm, in some examples, 10 ppm to 1000 ppm, in some examples, 10 ppm to 500 ppm, in some examples, 15 ppm to 250 ppm, in some examples, 20 ppm to 200 ppm, in some examples, 25 ppm to 150 ppm, in some examples, 30 ppm to 100 ppm, in some examples, 35 ppm to 95 ppm, in some examples 40 ppm to 90 ppm, in some examples, 45 ppm to 85 ppm, in some examples, 50 ppm to 80 ppm, in some examples, 55 ppm to 75 ppm, in some examples, 60 ppm to 70 ppm, in some examples, 40 ppm to 65 ppm catalyst.

### Thermal Inhibitor

In some examples, the release formulation comprises a thermal inhibitor. In some examples, the thermal inhibitor comprises an acetylenic alcohol or an alkanol. In some examples, the thermal inhibitor inhibits thermal curing of the polyalkylsiloxane containing at least two vinyl groups and the polyalkylsiloxane cross-linker, Although when the release formulation is a UV curable release formulation no catalyst for thermal activation of the cross-linking reaction is present, thermal curing may be initiated during high shear mixing of the release formulation due to degradation of the UV activated catalyst and therefore the presence of a thermal inhibitor suppresses this reaction, suppressing the associated increase in viscosity of the release formulation.

In some examples, the release formulation comprises 0.01 wt. % to 10 wt. % thermal inhibitor, in some examples, 0.05 wt. % to 9 wt. %, in some examples, 0.1 wt. % to 8 wt. %, in some examples, 0.1 wt. % to 7 wt. %, in some examples, 0.5 wt. % to 6 wt. %, in some examples, 1 wt. % to 5 wt. %, in some examples, 1.5 wt. % to 4 wt. %, in some examples, 2 wt. % to 3.5 wt. %, in some examples, 2.5 wt. % to 3 wt. % thermal inhibitor. In some examples, no thermal inhibitor is used.

Suitable examples of the thermal inhibitor include Inhibitor 600, Inhibitor 500 and Inhibitor 400 from Evonik. Other suitable thermal inhibitors include 1,3-divinyltetramethyldisiloxane (C₈H₁₈OSi₂) and 1,3,5,7-tetravinyl-1,3,5,7-tetramethylcyclo-tetrasiloxane (C₁₂H₂₄O₄Si₄), both from Gelest Inc.

### Conductive Particles

The release formulation may comprise conductive particles. In some examples, the conductive particles may be electrically conductive particles. In some examples, the conductive particles may be carbon black particles.

In some examples, the release formulation may comprise 0.01 wt. % to 10 wt. % conductive particles, in some examples, 0.05 wt. % to 9 wt. %, in some examples, 0.1 wt. % to 8 wt. %, in some examples, 0.25 wt. % to 7 wt. %, in some examples, 0.5 wt. % to 6 wt. %, in some examples, 0.75 wt. % to 5 wt. %, in some examples, 0.8 wt. % to 4 wt. %, in some examples, 0.85 wt. % to 3 wt. %, in some examples, 0.9 wt. % to 2.5 wt. %, in some examples, 0.95 wt. % to 2 wt. %, in some examples, 1 wt. % to 1.5 wt. % conductive particles.

Suitable examples of the conductive particles include carbon black particles from AkzoNobel under the name Ketjenblack® EC600JD.

### Method of Making the Release Formulation

In some examples, a polyalkylsiloxane containing at least two vinyl groups may be combined with a polyalkylsiloxane cross-linker containing at least two Si—H bonds.

In some examples, a polyalkylsiloxane containing at least two vinyl groups may be combined with conductive particles. In some examples, the polyalkylsiloxane containing at least two vinyl groups is combined with conductive particles under high shear mixing. In some examples, the high shear mixing is at 3,000 rpm or more, in some examples, 3,500 rpm or more, in some examples, 4,000 rpm or more, in some examples, 4,500 rpm or more, in some examples, 5,000 rpm or more, in some examples, 5,500 rpm or more, in some examples, 6,000 rpm or more, in some examples, 6,500 rpm or more, in some examples, 7,000 rpm or more, in some examples 7,500 rpm or more, in some examples, 8,000 rpm or more, in some examples, 8,500 rpm or more, in some examples, about 9,000 rpm. In some examples, the high shear mixing is at 9,000 rpm or less, in some examples, 8,500 rpm or less, in some examples, 8,000 rpm or less, in some examples, 7,500 rpm or less, in some examples, 7,000 rpm or less, in some examples, 6,500 rpm or less, in some examples, 6,000 rpm or less, in some examples, 5,500 rpm or less, in some examples, 5,000 rpm or less, in some examples, 4,500 rpm or less, in some examples, 4,000 rpm or less, in some examples, 3,500 rpm or less, in some examples, about 3,000 rpm. In some examples, the high shear mixing is at 3,000 rpm to 9,000 rpm, in some examples, 3,500 rpm to 8,500 rpm, in some examples, 4,000 rpm to 8,000 rpm, in some examples, 4,500 rpm to 7,500 rpm, in some examples, 5,000 rpm to 7,000 rpm, in some examples, 5,500 rpm to 6,500 rpm, in some examples, 6,000 rpm to 6,500 rpm.

In some examples, a polyalkylsiloxane containing at least two vinyl groups may be combined with conductive particles and then a polyalkylsiloxane cross-linker containing at least two Si—H bonds is added. In some examples, the composition is then protected from light, for example, by wrapping the container in aluminium foil or using a container formed from a light-proof material, before a catalyst, for example, a UV activated catalyst, may be added. In some examples, the catalyst, for example, the UV activated catalyst, may be used as a solution in a liquid carrier, for example, as a solution in dioxane (e.g., 1,4-dioxane), or as a solution in tetrahydrofuran (THF) or as a solution in 1,2,4-trioxolane, In some examples, the catalyst may be added as a solution in a liquid carrier, for example, as a solution in an alcohol, such as isopropanol, or an alkane, such as xylene. In some examples, a thermal inhibitor may be added. In some examples, the composition is subjected to high shear mixing to efficiently disperse the catalyst. In some examples, the high shear mixing is at 1,000 rpm or more, in some examples, 1,500 rpm or more, in some examples, 2,000 rpm or more, in some examples, 2,500 rpm or more, in some examples, 3,000 rpm or more, in some examples, 3,500 rpm or more, in some examples, 4,000 rpm or more, in some examples, 4,500 rpm or more, in some examples, about 5,000 rpm. In some examples, the high shear mixing is at 5,000 rpm or less, in some examples, 4,500 rpm or less, in some examples, 4,000 rpm or less, in some examples, 3,500 rpm or less, in some examples 3,000 rpm or less, in some examples, 2,500 rpm or less, in some examples, 2,000 rpm or less, in some examples, 1,500 rpm or less, in some examples, about 1,000 rpm. In some examples, the high shear mixing is at 1,000 rpm to 5,000 rpm, in some examples, 1,500 rpm to 4,500 rpm, in some examples, 2,000 rpm to 4,000 rpm, in some examples, 2,500 rpm to 3,500 rpm, in some examples, 3,000 rpm to 3,500 rpm.

In some examples, the temperature during mixing, for example, high shear mixing, is maintained at 100° C. or less, in some examples, at 95° C. or less, in some examples, at 90° C. or less, in some examples, 85° C. or less, in some examples, 80° C. or less, in some examples, 75° C. or less, in some examples, 70° C. or less, in some examples, 65° C. or less, in some examples, 60° C. or less, in some examples, 55° C. or less, in some examples, 50° C. or less.

In some examples, the UV curable release formulation is stored in the dark.

### Printing Apparatus

In some examples, the intermediate transfer member blanket may be for use in a digital offset printing apparatus. In some examples, the digital offset printing apparatus may be an electrostatic printer or a transfer inkjet printer. In some examples, the electrostatic printer may be a dry toner electrostatic printer or a liquid electrostatic printer. In some examples, the electrostatic printer may be a liquid electrostatic printer.

In some examples, a transfer inkjet printing apparatus is an inkjet printing apparatus in which the ink is jetted onto an intermediate transfer member to form an image on the intermediate transfer member before the image is transferred from the intermediate transfer member to a substrate. In some examples, the digital offset printing apparatus is a liquid electrostatic (LEP) printing apparatus.

The intermediate transfer member blanket for use in a digital offset printing apparatus may be in the form of an endless belt and comprise a seamless release layer formed by curing a curable silicone release formulation comprising a polyalkylsiloxane containing at least two vinyl groups and a polyalkylsiloxane cross-linker containing at least two Si—H bonds.

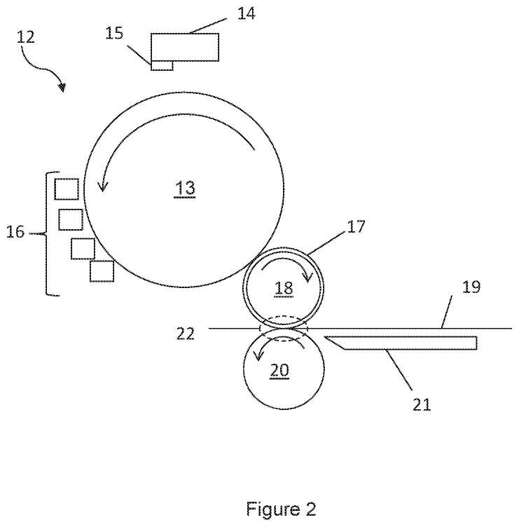

FIG. 2 shows a schematic illustration of an example of a liquid electrophotographic (LEP) printing apparatus 12 and the use of an intermediate transfer member 18 therein. An image, including any combination of graphics, text and images, is communicated to the LEP printing apparatus 12. The LEP printing apparatus includes a photo charging unit 14 and a photo-imaging cylinder 13. The image is initially formed on a photoimaging plate (also known as a photoconductive member), in this case in the form of photo-imaging cylinder 13, before being transferred to a release layer 17 of the intermediate transfer member (ITM) 18 which is in the form of a roller (first transfer), and then from the release layer 17 of the ITM 18 to a print substrate 19 (second transfer).

According to an illustrative example, the initial image is formed on rotating photo-imaging cylinder 13 by photo charging unit 14. Firstly, photo charging unit 14 deposits a uniform static charge on photo-imaging cylinder 13 and then a laser imaging portion 15 of photo charging unit 14 dissipates the static charges in selected portions of the image area on the photo-imaging cylinder 13 to leave a latent electrostatic image. The latent electrostatic image is an electrostatic charge pattern representing the image to be printed. Liquid electrophotographic ink is then transferred to photo-imaging cylinder 13 by binary ink developer (BID) units 16. The BID units 16 present a uniform film of liquid electrophotographic ink to photo-imaging cylinder 13. The liquid electrophotographic ink contains electrically charged pigment particles which, by virtue of an appropriate potential on the electrostatic image areas, are attracted to the latent electrostatic image on photo-imaging cylinder 13. The liquid electrophotographic ink does not adhere to the uncharged, non-image areas and forms a developed toner image on the surface of the latent electrostatic image. Photo-imaging cylinder 13 then has a single colour ink image on its surface.

The developed toner image is then transferred from photo-imaging cylinder 13 to the release layer 17 of ITM 18 by electrical forces. The image is then dried and fused on release layer 17 of ITM 18 before being transferred from the release layer 17 of ITM 18 to a print substrate 19 disposed on impression cylinder 20. The process may then be repeated for each of the coloured ink layers to be included in the final image.

The image is transferred from photo-imaging cylinder 13 to ITM 18 by virtue of an appropriate potential applied between photo-imaging cylinder 13 and ITM 18, such that the charged ink is attracted to ITM 18.

Between the first and second transfers, the solid content of the developed toner image is increased and the ink is fused on to the ITM 18. For example, the solid content of the developed toner image deposited on release layer 17 after the first transfer is typically around 20%, by the second transfer the solid content of the developed toner image is typically around 80-90%. This drying and fusing is typically achieved by using elevated temperatures and airflow-assisted drying. In some examples, ITM 18 is heatable.

The print substrate 19 is fed into the printing apparatus by print substrate feed tray 21 and is disposed on impression cylinder 20. As print substrate 19 contacts ITM 18, the single colour image is transferred to print substrate 19.

To form a single colour image (such as a black and white image), one pass of print substrate 19 through the nip 22 between impression cylinder 20 and ITM 18 completes the image. For a multiple colour image, print substrate 19 may be retained on the impression cylinder 20 and make multiple contacts with ITM 18 as it passes through nip 22. At each contact an additional colour plane may be placed on print substrate 19.

### Intermediate Transfer Member

The intermediate transfer member may be termed an ITM herein for brevity. The ITM may comprise a supportive portion on which the release layer is disposed. The supportive portion may be termed an endless belt intermediate transfer member blanket precursor herein.

The ITM may have a base, for example, a metal base. The base may form part of the supportive portion of the ITM. The seamless intermediate transfer member blanket may be disposed on the base. The base may have a cylindrical shape. The base may comprise multiple rollers, optionally multiple cylindrical rollers, wherein the multiple rollers may be positioned such that the seamless intermediate transfer member blanket is under tension.

The ITM may have a cylindrical shape; as such, the ITM may be suitable for use as a roller, for example, a roller in a digital offset printing apparatus.

The supportive portion of the ITM may comprise a layered structure disposed on the base of the ITM. The supportive portion may comprise a layer comprising a thermoplastic polyurethane.

The layered structure may comprise a compliant substrate layer, for example, a rubber layer or a layer comprising a thermoplastic polyurethane, on which the release layer may be disposed. The compliant substrate layer may comprise a thermoplastic polyurethane layer or a rubber layer. The rubber layer may comprise an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ or FLS), a fluorocarbon rubber (FKM or FPM) or a perfluorocarbon rubber (FFKM).

The ITM may comprise a primer layer to facilitate bonding or joining of the release layer to the compliant layer. The primer layer may form part of the supportive portion of the ITM, in some examples, the primer layer is disposed on the compliant substrate layer.

In some examples, the primer layer is formed by curing a primer formulation.

In some examples, the primer formulation may comprise an organosilane, for example, an organosilane derived from an epoxysilane such as 3-glycidoxypropyltrimethoxysilane, a vinyl silane such as vinyltriethoxysilane or vinyltrimethoxysilane, an allyl silane, an acryloxysilane such as 3-methacryloxypropyltrimethoxysilane, or an unsaturated silane, and a catalyst such as a catalyst comprising titanium or platinum.

The primer layer may be formed from a curable primer formulation. The curable primer formulation may be applied to the compliant substrate layer of the supportive portion of the ITM before a release formulation is applied to the supportive portion. The curable primer formulation may comprise an organosilane and a catalyst, for example, a catalyst comprising titanium.

In some examples, the organosilane contained in the curable primer formulation is selected from an epoxysilane, a vinyl silane, an allyl silane and an unsaturated silane.

The curable primer formulation may comprise a first primer and a first catalyst, and a second primer and, in some examples, a second catalyst. The first primer and/or the second primer may comprise an organosilane. The organosilane may be selected from an epoxysilane, a vinyl silane, an allyl silane and an unsaturated silane.

In some examples, the first catalyst is a catalyst for catalysing a condensation cure reaction, for example, a catalyst comprising titanium. The first primer may be cured by a condensation reaction by the first catalyst. The second primer may be cured by a condensation reaction by the first catalyst.

In some examples, the second catalyst is a catalyst for catalysing an addition cure reaction.

The curable primer formulation may be applied to the compliant layer as a composition containing the first and second primer and first and second catalyst.

In some examples, the curable primer formulation may be applied to the compliant layer as two separate compositions, one containing the first primer and first catalyst, the other containing the second primer and second catalyst. In some examples, the curable primer formulation may be applied as two separate compositions, one containing the first primer (e.g., (3-glycidoxypropyl)trimethoxysilane and/or 3-methacryloxypropyltrimethoxysilane) and a photoinitiator (e.g., 2-hydroxy-2-methylpropiophenone), the other containing the second primer (e.g., (3-glycidoxypropyl)trimethoxysilane and/or vinyltrimethoxysilane) and a catalyst (e.g., titanium diisopropoxide bis(acetylacetonate) and/or platinum divinyltetramethyldisiloxane).

In some examples, the ITM may comprise an adhesive layer for joining the compliant substrate layer to the base. The adhesive layer may be a fabric layer, for example, a woven or non-woven cotton, synthetic, combined natural and synthetic, or treated, for example, treated to have improved heat resistance, material.

The compliant substrate layer may be formed of a plurality of compliant layers. For example, the compliant substrate layer may comprise a compressible layer, a compliance layer and/or a conductive layer. A “conductive layer” may be a layer comprising electrically conductive particles. In some examples, any one or more of the plurality of compliant layers may comprise a thermoplastic polyurethane.

In some examples, the compressible layer is disposed on the base of the ITM. The compressible layer may be joined to the base of the ITM by the adhesive layer. A conductive layer may be disposed on the compressible layer. The compliance layer may then be disposed on the conductive layer, if present, or disposed on the compressible layer if no conductive layer is present. If the compressible layer and/or the compliance layer are partially conducting there may be no requirement for an additional conductive layer.

The compressible layer may have a large degree of compressibility. In some examples, the compressible layer may be 600 μm thick.

The compressible layer may comprise a thermoplastic polyurethane layer, a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), or a fluorosilicone rubber (FLS). In some examples, the compressible layer may comprise carbon black to increase its thermal conductivity.

In some examples, the compressible layer includes small voids, which may be as a result of microspheres or blowing agents used in the formation of the compressible layer. In some examples, the small voids comprise about 40% to about 60% by volume of the compressible layer.

The compliance layer may comprise a thermoplastic polyurethane, a soft elastomeric material having a Shore A hardness value of less than about 65, or a Shore A hardness value of less than about 55 and greater than about 35, or a Shore A hardness value of between about 42 and about 45. In some examples, the compliance layer comprises a polyurethane, a thermoplastic polyurethane or an acrylic. Shore A hardness is determined by ASTM standard D2240.

In some examples, the compliance layer comprises an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ), a fluorocarbon rubber (FKM or FPM) or a perfluorocarbon rubber (FFKM). In some examples, the compliance layer comprises a thermoplastic polyurethane.

In an example the compressible layer and the compliance layer are formed from the same material.

The conductive layer may comprise a rubber, for example, an acrylic rubber (ACM), a nitrile rubber (NBR), a hydrogenated nitrile rubber (HNBR), or an EPDM rubber (an ethylene propylene diene terpolymer), and one or more conductive materials, including but not limited to carbon black or metallic particles. In some examples, the conductive layer may comprise a thermoplastic polyurethane and one or more conductive materials, including but not limited to carbon black or metallic particles.

In some examples, the compressible layer and/or the compliance layer may be made to be partially conducting with the addition of conducting particles, for example, conductive carbon black, metal particles or metal fibres. In some examples, where the compressible layer and/or the compliance layer are partially conducting there may be no requirement for an additional conductive layer.

In some examples, the seamless intermediate transfer member blanket comprises, in the following order:
a. a fabric layer;
b. a compressible layer, which may have voids therein;
c. a layer comprising electrically conductive particles;
d. an optional compliant layer; and
e. a seamless release layer;

FIG. 3 is a cross-sectional diagram of an example of an ITM 18. The ITM 18 includes a supportive portion comprising a base 23 and a substrate layer 24 (an intermediate transfer member blanket precursor) disposed on the base 23. The base 23 may be a metal cylinder. The substrate layer 24 may comprise or be a thermoplastic polyurethane layer. The ITM 18 also comprises a seamless release layer 17 disposed on the substrate layer 24.

The substrate layer 24 may comprise or further comprise (if it also comprises a thermoplastic polyurethane layer) a rubber layer which may comprise an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ or FLS), a fluorocarbon rubber (FKM or FPM) or a perfluorocarbon rubber (FFKM). For example, the rubber layer may comprise an at least partly cured acrylic rubber, for example, an acrylic rubber comprising a blend of acrylic resin Hi-Temp 4051 EP (Zeon Europe GmbH, Niederkasseler Lohweg 177, 40547 Düsseldorf, Germany) filled with carbon black pearls 130 (Cabot, Two Seaport Lane, Suite 1300, Boston, Mass. 02210, USA) and a curing system which may comprise, for example, NPC-50 accelerator (ammonium derivative from Zeon).

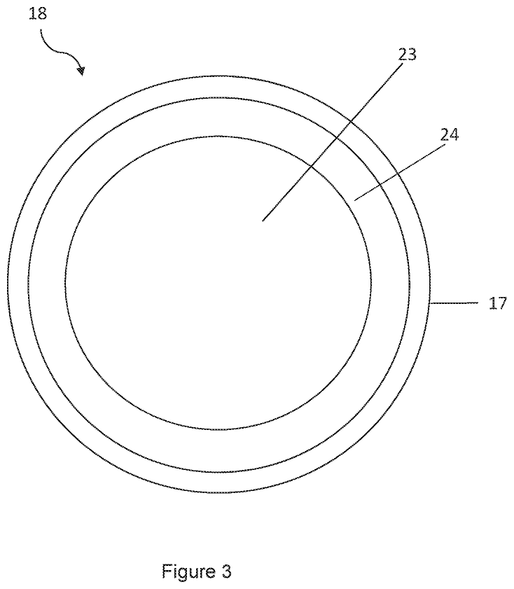

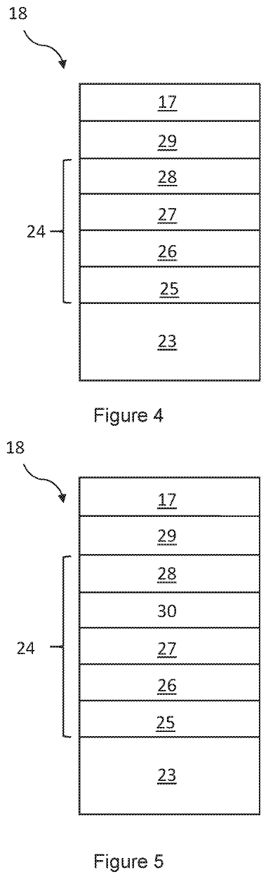

FIG. 4 shows a cross-sectional view of an example of an ITM 18 having a substrate layer 24 (intermediate transfer member blanket precursor) comprising an adhesive layer 25 disposed between the base 23 and a compressible layer 26 for joining the compressible layer 26 of the substrate layer 24 to the base 23, a conductive layer 27 may be disposed on the compressible layer 26, and a compliance layer 28 (also called a soft compliant layer) may be disposed on the conductive layer 27. A primer layer 29 is disposed between the substrate layer 24 and the release layer 17. At least one of the layers 25 to 28 may comprise a thermoplastic polyurethane.

FIG. 5 shows a cross-sectional view of an ITM 18 having a substrate layer 24 comprising an adhesive layer 25 disposed between the base 23 and a compressible layer 26 for joining the compressible layer 26 of the substrate layer 24 to the base 23, a conductive layer 27 is disposed on the compressible layer 26, a layer comprising a thermoplastic polyurethane 30 is disposed on the conductive layer 27, and a compliance layer 28 (also called a soft compliant layer) is disposed on the thermoplastic polyurethane 30. The release layer 17 is disposed on a primer layer 29, which is disposed on the compliance layer 28.

The adhesive layer may be a fabric layer, for example a woven or non-woven cotton, synthetic, combined natural and synthetic, or treated, for example, treated to have improved heat resistance, material. In an example the adhesive layer 25 is a fabric layer formed of NOMEX material having a thickness, for example, of about 200 μm.

The compressible layer 26 may be a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), or a fluorosilicone rubber (FLS). The compressible layer may comprise a thermoplastic polyurethane.

The compliance layer 28 may comprise a soft elastomeric material having a Shore A hardness value of less than about 65, or a Shore A hardness value of less than about 55 and greater than about 35, or a Shore A hardness value of between about 42 and about 45. In some examples, the compliance layer 28 comprises a polyurethane or acrylic. In some examples, the compliance layer 28 comprises a thermoplastic polyurethane. Shore A hardness is determined by ASTM standard D2240. In some examples, the compliance layer comprises an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ), a fluorocarbon rubber (FKM or FPM) or a perfluorocarbon rubber (FFKM)

In an example, the compressible layer 26 and the compliance layer 28 are formed from the same material.

In some examples, the conductive layer 27 comprises a rubber, for example, an acrylic rubber (ACM), a nitrile rubber (NBR), a hydrogenated nitrile rubber (HNBR), or an EPDM rubber (an ethylene propylene diene terpolymer), and one or more conductive materials. In some examples, the conductive layer 27 comprises a thermoplastic polyurethane and one or more conductive materials. In some examples, the conductive layer 27 may be omitted, such as in some examples in which the compressible layer 26, the compliance layer 28, or the release layer 17 are partially conducting. For example, the compressible layer 26 and/or the compliance layer 28 may be made to be partially conducting with the addition of conductive carbon black or metal fibres.

The primer layer 29 may be provided to facilitate bonding or joining of the release layer 17 to the substrate layer 24. The primer layer 29 may comprise an organosilane, for example, an organosilane derived from an epoxysilane such as 3-glycidylpropyl trimethoxysilane, a vinyl silane such as vinyltriethoxysilane or vinyltrimethoxysilane, an allyl silane, an unsaturated silane or a (meth)acrylic silane, for example, 3-methacryloxypropyltrimethoxysilane, and a catalyst such as a catalyst comprising titanium or platinum.

In an example, a curable primer formulation 29 is applied to a compliance layer 28 of a substrate layer 24, for example, to the outer surface of a compliance layer 28 made from an acrylic rubber. The curable primer formulation may be applied using a rod coating process. The curable primer may comprise a first primer comprising an organosilane and a first catalyst comprising titanium, for example, an organic titanate or a titanium chelate. In an example, the organosilane is an epoxysilane, for example, 3-glycidoxypropyl trimethoxysilane (available from ABCR GmbH & Co. KG, Im Schlehert 10 D-76187, Karlsruhe, Germany, product code SIG5840) and vinyltriethoxysilane (VTEO, available from Evonik, Kirschenallee, Darmstadt, 64293, Germany), vinyltrimethoxysilane, an allyl silane, an unsaturated silane or a (meth)acrylic silane, for example, 3-methacryloxypropyltrimethoxysilane. The first primer is curable by, for example, a condensation reaction. For example, the first catalyst for a silane condensation reaction may be an organic titanate such as Tyzor® AA75 (available from Dorf-Ketal Chemicals India Private Limited Dorf Ketal Tower, D'Monte Street, Orlem, Malad (W), Mumbai-400064, Maharashtra, INDIA), The primer may also comprise a second primer comprising an organosilane, e.g., a vinyl siloxane, such as a vinyl silane, for example, vinyl triethoxy silane, vinyltrimethoxysilane, an allyl silane, an unsaturated silane or a (meth)acrylic silane, for example, 3-methacryloxypropyltrimethoxysilane, and, in some examples, a second catalyst. The second primer may also be curable by a condensation reaction. The second catalyst, if present, may be different from the first catalyst and in some examples comprises platinum or rhodium. For example, the second catalyst may be a Karstedt catalyst with, for example, 9% platinum in solution (available from Johnson Matthey, 5th Floor, 25 Farringdon Street, London EC4A 4AB, United Kingdom) or a SIP6831.2 catalyst (available from Gelest, 11 East Steel Road, Morrisville, Pa. 19067, USA). This second primer may be cured by an addition reaction. The second catalyst in the second primer may be in contact with a pre-cure release formulation applied onto the primer layer 29.

The curable primer formulation applied to the substrate layer 24 may comprise a first primer and/or a second primer as described herein. The curable primer formulation may be applied to the substrate layer 24 as two separate layers (formulations), one layer containing the first primer and the other layer containing the second primer.

The rubbers of the compressible layer 26, the conductive layer 27 and/or the compliance layer 28 of the substrate layer 24 may be uncured when the curable primer layer is applied thereon.

The release layer 17 of the ITM 18 may be a release layer that is formed by UV curing a UV curable release formulation as described herein. The release layer 17 of the ITM 18 may be a release layer that is formed by thermally curing a thermally curable release formulation as described herein.

The release layer 17 may be formed on the ITM by applying a layer of the release formulation to a supportive portion of the ITM by using the method described herein. For example, the release layer may be applied to the substrate layer 24 or on top of a curable primer layer 29 which has already been applied to the substrate layer 24. The curable primer layer and the release formulation may have been cured at the same time.

In some examples, once cured, the ITM comprises a seamless release layer 17 disposed on a substrate layer 24, or, if present, disposed on a primer layer 29.

In some examples, the release formulation forms a polymer matrix on curing, thus forming the cured release layer.

### EXAMPLES

The following illustrates examples of the compositions and related aspects described herein. Thus, these examples should not be considered to restrict the present disclosure, but are merely in place to teach how to make examples of compositions of the present disclosure.

### Materials

Primer G [(3-glycidoxypropyl)trimethoxysilane; an epoxysilane; available from ABCR and Sigma-Aldrich]:

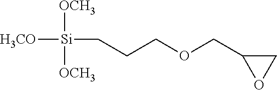 [SMILES: CO[Si](CCCOCC1CO1)(OC)OC]

V3M (vinyltrimethoxysilane; a vinyl silane; available from ABCR and Sigma-Aldrich):

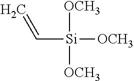

Polymer VS500 (vinyl-terminated polydimethylsiloxane; available from Evonik Industries):

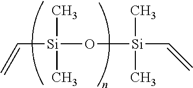

Polymer RV 5000 (pendent vinyl polydimethylsiloxane; available from Evonik Industries):

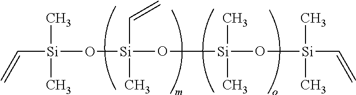

Cross-linker 210 (CL210; a polydimethylsiloxane containing at least two Si—H bonds; available from Evonik Industries):

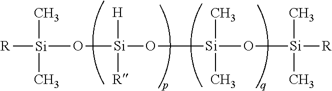

in which R═H or Me.

Inhibitor 600 (an alkinol in Polymer VS; available from Evonik Industries).

Tyzor AA-75 (75 wt. % in isopropanol; available from Dorf-Ketal)

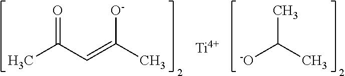

Karstedt's catalyst (platinum divinyl tetramethyl disiloxane complex; ˜10 wt. % in xylene; purchased from Johnson Matthey):

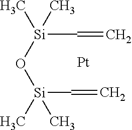

Catalyst 510 (0.5% platinum in isopropanol; available from Evonik Industries):

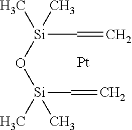

Ketjenblack® EC600JD (carbon black; available from AkzoNobel).

PM3 3POUR-VAE01 (polytetrafluoroethylene membrane; 25±5 μm thickness; 10-13 g/m²; available from Novotex).

Hostaphan (polyethylene terephthalate membrane; 50 μm thickness; 1.39 g/cm²; available from Mitsubishi Polyester film).

Nirotek P25 (polyethylene foil; 60 μm thickness; 80 g/m²; available from Nirotek). Knight Smooth Digital (Indigo uncoated paper; 130 μm thickness; 120 g/m²; available from K.W. Dogget Fine Paper).

### Curable Silicone Release Formulation

TABLE 1

| | | Dynamic | Functional |
|---|---|---|---|
| | Amount | viscosity | group |
| Materials | [parts by weight] | [mPa · s] | content [mmol/g] |
| Vinyl-terminated | 80 | 500 | 0.14 vinyl |
| polydimethylsiloxane | | | |
| (vs500) | | | |
| Pendent vinyl | 20 | 3000 | 0.4 vinyl |
| polydimethylsiloxane | | | |
| (RV 5000) | | | |
| Polydimethylsiloxane | 10 | 900 | 4.2 Si—H |
| cross-linker | | | |
| (CL210) | | | |
| Inhibitor 600 | 5 | 900 | 0.11 vinyl |
| Catalyst 510 | 0.5 | 500 | 0.14 vinyl |
| Carbon black | 0.8 wt. % | | |

In accordance with Table 1, vinyl-terminated polydimethylsiloxane (polymer VS500) was mixed with a pendent vinyl polydimethylsiloxane (polymer RV 5000). To this mixture was added conductive particles (carbon black) and the mixture was homogenized at 6000 rpm using a high-shear mixer. After homogenization, a polydimethylsiloxane cross-linker containing at least two Si—H bonds (CL210) was added to a final hydride/vinyl mole ratio of approximately 2:1. Inhibitor 600 was then added, followed by thermally activated platinum catalyst (Catalyst 510; 0.5 wt. % Pt). Finally, the mixture was homogenized at 3000 rpm for 5 minutes. This formulation may be kept for 2 to 3 hours when kept tightly sealed.

### Curable Primer Formulation

TABLE 2

| Materials | Amount [wt. %] |
|---|---|
| Epoxysilane | 52 |
| (Primer G) | |
| Vinyl silane | 35 |
| (V3M) | |
| First catalyst | 10 |
| (Tyzor AA-75) | |
| Second catalyst | 3 |
| (Karstedt solution 9 wt. % Pt) | |

In accordance with Table 2, an epoxysilane (Primer G), a vinyl silane (V3M), a first catalyst (Tyzor AA-75) and a second catalyst (Karstedt solution; 9 wt. % Pt) were combined to form a curable primer formulation.

### Preparation of the Seamless Intermediate Transfer Member Blanket

An endless belt of an intermediate transfer member blanket precursor comprising a soft compliant layer disposed on a layer comprising electrically conductive particles disposed on a compressible layer having voids therein disposed on a fabric layer (endless belt length: 4917 mm; width: 358 mm) was provided. The compliant layer forms the outer surface of the endless belt intermediate transfer member blanket precursor. The endless belt of the intermediate transfer member blanket precursor was placed in a closed loop gravure printer (as shown in FIG. 1 and containing a primer applicator roller (hexagonal anilox roller having a 60° angle and 10.50 cm³/m²) and an applicator roller (hexagonal anilox roller having a 60° angle and 13.80 cm³/m² volume).

The endless belt travelled around the closed loop gravure printer at a speed of 5 m/min with each point on the endless belt passing from the primer applicator roller to the applicator roller before travelling through the oven and potentially returning passed the primer applicator roller and the applicator roller. Additionally, the roller speed of the primer applicator roller and applicator roller was 5 m/min.

The primer applicator roller was contacted with the outer surface of the endless belt to apply the primer formulation at a primer layer thickness of 2±0.5 μm and was maintained in contact with the endless belt as the endless belt travelled around the closed loop gravure printer.

The applicator roller was contacted with the outer surface of the endless belt to apply the release formulation to the primer formulation at a release layer thickness of 5±0.5 μm.

The release formulation was cured by travelling through three oven dryers which were at a temperature of 60° C.

A polytetrafluoroethylene membrane (PM3 3POUR-VAE01: length; 200 mm; width: 358 mm) was applied (by hand) to the cured release layer across the full width of the endless belt.

Once the entire outer surface of the endless belt had been coated with the primer formulation, the primer applicator roller was disengaged such that it was no longer in contact with the endless belt.

The endless belt continued to travel around the closed loop gravure printer until the applicator roller contacted the polytetrafluoroethylene membrane such that the applicator roller at least partially coated the polytetrafluoroethylene membrane with the release formulation. The applicator roller was disengaged when the applicator roller was in contact with the polytetrafluoroethylene membrane and consequently at least a portion of the polytetrafluoroethylene membrane was not coated with the release formulation.

The polytetrafluoroethylene membrane was removed from the surface of the release layer. The endless belt continued to travel around the closed loop gravure printer until the entire release layer had travelled through the three oven dryers.

The release layer was fully cured by placing endless belt in a post-curing oven at a temperature of 120° C. for 1 h to form the seamless intermediate transfer member blanket.

### Preparation of Reference Intermediate Transfer Member Blankets

### Reference 1—No Membrane

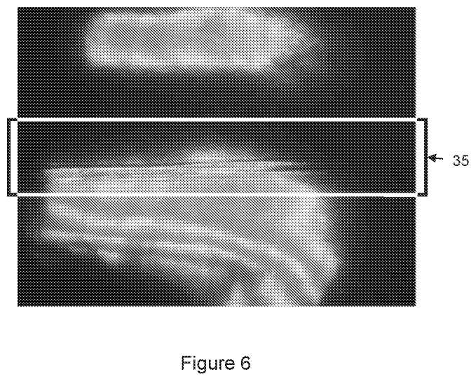

The Reference 1 intermediate transfer member blanket was prepared by following the same procedure described above to prepare the intermediate transfer member blanket except that no fluoropolymer membrane was applied to the release layer. The applicator roller was therefore disengaged when in contact with the release layer leaving seam in the release layer of the intermediate transfer member blanket. FIG. 6 shows the seam (35) in the release layer formed when the applicator roller was disengaged.

### Reference 2—Polyethylene Terephthalate Membrane

The Reference 2 intermediate transfer member blanket was prepared by following the same procedure described above to prepare the seamless intermediate transfer member blanket except that a polyethylene terephthalate membrane was applied to the release layer instead of the fluoropolymer membrane.

The applicator roller was therefore disengaged when in contact with the polyethylene terephthalate membrane. Removal of the polyethylene terephthalate membrane from the release layer altered the surface texture of the cured release layer, resulting in a seam in the release layer of the intermediate transfer member blanket.

### Reference 3—Polyethylene Membrane

The Reference 3 intermediate transfer member blanket was prepared by following the same procedure described above to prepare the seamless intermediate transfer member blanket except that a polyethylene membrane was applied to the release layer instead of the fluoropolymer membrane.

The applicator roller was therefore disengaged when in contact with the polyethylene membrane. Removal of the polyethylene membrane from the release layer altered the surface texture of the cured release layer, resulting in a seam in the release layer of the intermediate transfer member blanket.

### Reference 4—Paper

The Reference 4 intermediate transfer member blanket was prepared by following the same procedure described above to prepare the seamless intermediate transfer member blanket except that paper (uncoated) was applied to the release layer instead of the fluoropolymer membrane.

The applicator roller was therefore disengaged when in contact with the paper. Removal of the paper from the release layer altered the surface texture of the cured release layer, resulting in a seam in the release layer of the intermediate transfer member blanket.

### Chemico-Physical Properties of the Intermediate Transfer Blankets

TABLE 3

| | Blanket away | Disengage area (seam) |
|---|---|---|
| | from disengage area | Example (PTFE) |
| Gloss 60° | 69.5 | 68 |
| Δ Gloss | 28.2 | 27.6 |
| Swelling degree | 0.39 | 0.38 |
| Contact angle (0) H₂O | 111.1 ± 0.11 | 101.29 ± 1.74 |
| Contact angle (0) CH₃I | 70.02 ± 0.21 | 71.05 ± 1.24 |
| Surface energy [mN/m] | 23.31 ± 0.33 | 22.61 ± 0.93 |
| Roughness Ra [μm] | 0.504 | 0.488 |
| Roughness Sa [μm] | 0.526 | 0.546 |
| RL thickness [μm] | 5.44 ± 0.5 | 5.61 ± 0.5 |

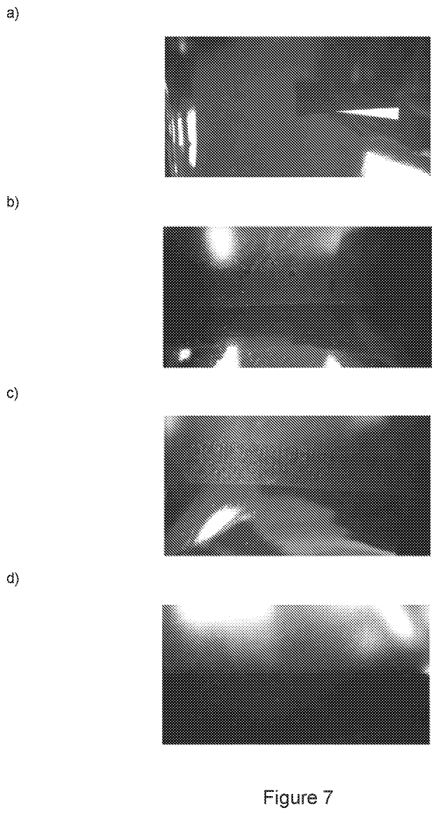

Visual inspection of the surface of the Reference 2 (PET), 3 (PE) and 4 (paper) intermediate transfer member blankets showed that the surface in the area that had been under the PET, PE or paper membranes were very different from the remaining portions of the intermediate transfer blankets (see FIGS. 7b to d respectively). The use of the PET, PE and paper membranes resulted in a very different surface texture in the area of the release layer that had been under the membrane. In contrast, the properties of the polytetrafluoroethylene membrane (for example, its hydrophobicity, low thickness, and high porosity) enabled it to be removed without detrimentally affecting the surface of the release layer (see FIG. 7a). As can be seen from Table 3 above, it can be concluded that there is no difference in the chemico-physical properties of the intermediate transfer member blanket in the area under the PTFE membrane and the rest of the intermediate transfer member blanket area.

### Printing Press Performance

Basic printing quality tests were performed to compare the printing quality in the area that was under the PTFE membrane with the printing quality of the rest of the intermediate transfer member blanket as well as with the printing quality of the area away from the seam of current commercially available intermediate transfer member blankets. No differences in printing quality were observed.

### Test Methods

### Gloss Test

The gloss tests were performed by using the Micro-Tri Gloss test machine (available from BYK-Gardner). A measurement angle of 60° between the incident light and the perpendicular was used. Δ gloss is the difference between the gloss of the dry release layer and the gloss of a swollen release layer (swollen with Isopar L).

A swollen release layer was obtained by contacting Isopar L (2 mL) with the intermediate transfer member for 3 minutes so that the Isopar L penetrates into the intermediate transfer member blanket. Excess Isopar L was wiped from the surface of the intermediate transfer member blanket before the gloss test was performed.

### Swelling Degree (Determined by the FT-IR Method Developed by Hewlett-Packard)

In the swelling degree tests, the C—H vibration is monitored by FT-IR. A multi-bounce ATR tool equipped with a ZnSe crystal at 45° was used.

The IR spectrum of a pristine dry intermediate transfer member blanket was measured. A puddle of Isopar L (2 mL) was then placed on the intermediate transfer member blanket for 3 minutes so that the Isopar L penetrates into the intermediate transfer member blanket. Excess Isopar L was wiped from the surface of the intermediate transfer member blanket and the IR spectrum of the swollen intermediate transfer member blanket was measured. The spectrum of the pristine dry intermediate transfer member blanket was subtracted from the spectrum of the swollen intermediate transfer member blanket. The amount of Isopar L was calculated from the peak area ratio of the methylene/methyl peaks on the spectrum after subtraction.

### Contact Angle and Surface Energy

The contact angle and surface energy were determined by using the Mobile Surface Analyser machine (available from Krüss).

The Mobile Surface Analyzer measures the wettability of a sample based on the contact angles. To determine the surface free energy of a solid surface, two test liquids are used [one polar (water) and one non-polar (diiodomethane)]. With one click of the Mobile Surface Analyser, both liquids were automatically dosed onto the surface of the intermediate transfer member blanket and the contact angles were simultaneously measured and used to derive the surface free energy.

### Roughness

The arithmetical mean deviation of the assessed 2D (line) profile (Rₐ) and the 3D (area) profile (Sₐ) were measured by using confocal microscopy (using a LEXT 3D measuring Laser microscope (OLS4000) available from Olympus).

### Release Layer (RL) Thickness

The release layer thickness was measured by assessing a cross-section of the intermediate transfer member blanket by using optical microscopy (using a BX51 optical microscope available from Olympus).

While the method and related aspects have been described with reference to certain examples, those skilled in the art will appreciate that various modifications, changes, omissions, and substitutions can be made without departing from the spirit of the disclosure. It is intended, therefore, that the present method and related aspects be limited only by the scope of the following claims. The features of any dependent claim can be combined with the features of any of the other dependent claims or independent claims.

1. A method of producing a seamless intermediate transfer member blanket, the method comprising:
applying a release formulation to an endless belt intermediate transfer member blanket precursor by contacting an applicator roller with an outer surface of the intermediate transfer member blanket precursor;
curing the release formulation to form a release layer;
applying a fluoropolymer membrane to a portion of the release layer;
disengaging the applicator roller when the applicator roller is in contact with the fluoropolymer membrane, such that the fluoropolymer membrane is at least partially coated with the release formulation; and
removing the fluoropolymer membrane from the surface of the release layer to form the seamless intermediate transfer member blanket.

2. The method according to claim 1, wherein the fluoropolymer is selected from polytetrafluoroethylene, fluorinated ethylene-propylene copolymers; and perfluoroalkoxy alkane polymers.

3. The method according to claim 1, wherein the fluoropolymer membrane has a thickness of 15 μm to 35 μm.

4. The method according to claim 1, wherein the fluoropolymer membrane is removed from the surface of the release layer before the release formulation that is partially coated on the fluoropolymer membrane is cured.

5. The method according to claim 1, wherein prior to applying the release formulation, a primer formulation is applied to the endless belt intermediate transfer member blanket precursor.

6. The method according to claim 5, wherein the primer formulation is applied by contacting a primer applicator roller with the outer surface of the intermediate transfer member blanket precursor.

7. The method according to claim 1, wherein the applicator roller comprises gravure cells on the surface of the applicator roller.

8. The method according to claim 1, wherein the applicator roller speed is from 1 m/min to 10 m/min.

9. The method according to claim 1, wherein an impression roller is positioned to provide a nip point between the applicator roller and the impression roller.

10. The method according to claim 1, wherein the endless belt intermediate transfer member blanket precursor comprises one or more of a fabric layer, a compressible layer, a conductive layer and a soft compliant layer.

11. The method according to claim 1, wherein the endless belt intermediate transfer member blanket precursor comprises a soft compliant layer disposed on a conductive layer disposed on a compressible layer disposed on a fabric layer, wherein the outer surface of the endless belt intermediate transfer member blanket precursor comprises the soft compliant layer.

12. The method according to claim 1, wherein the release formulation is a curable silicone release formulation comprising:
a polyalkylsiloxane containing at least two vinyl groups; and
a polyalkylsiloxane cross-linker containing at least two Si—H bonds.

13. A method according to claim 1, wherein the method is performed on a closed loop gravure printing press.

14. An intermediate transfer member blanket for use in an electrostatic printer;
wherein the intermediate transfer member blanket is in the form of an endless belt and comprises a seamless release layer formed by curing a curable silicone release formulation comprising:
a polyalkylsiloxane containing at least two vinyl groups; and
a polyalkylsiloxane cross-linker containing at least two Si—H bonds.

15. An intermediate transfer member comprising:
a seamless intermediate transfer member blanket obtainable by the method of claim 1; and
a base on which the blanket is disposed.
